(19) United States
(12) Patent Application Publication
(10) Pub. No.: US 2008/0071077 A1
(43) Pub. Date: Mar. 20, 2008

(54) Cosmetic formulations comprising carboxymethyl cellulose

(75) Inventors: Berend Jan Dijk, Duiven (NL); James J. Reid, Naugatuck, CT (US); Steve Manderino, Oakville, CT (US)

Correspondence Address: AKZO NOBEL INC., INTELLECTUAL PROPERTY DEPARTMENT, 120 WHITE PLAINS ROAD 3RD FLOOR, TARRTOWN, NY, 10591, US

(73) Assignee: Akzo Nobel N.V., Arnhem (NL)

(21) Appl. No.: 11/895,731

(22) Filed: Aug. 27, 2007

Related U.S. Application Data
(60) Provisional application No. 60/840,090, filed on Aug. 25, 2006.

(51) Int. Cl. C08B 1/00

(52) U.S. Cl. 536/56

(57) ABSTRACT

The invention relates to a cosmetic formulation comprising 0.01 to 5% by weight, based on the total weight of the formulation, of a carboxymethyl cellulose (CMC), wherein the CMC is characterized by forming a gel at 25° C. after high-shear dissolution in a 0.3 wt % aqueous sodium chloride solution, the final content of the CMC in the aqueous sodium chloride solution being 1 wt % for a CMC having a degree of polymerization (DP) of >4,000, 1.5 wt % for a CMC having a DP of 3,000-4,000, 2 wt % for a CMC having a DP of 1,500-<3,000, and 4 wt % for a CMC having a DP of <1,500, the gel being a fluid having a storage modulus (G′) which exceeds the loss modulus (G″) over the entire frequency region of 0.01-10 Hz when measured on an oscillatory rheometer operating at a strain of 0.2.

### FIELD OF THE INVENTION

The present invention relates to cosmetic formulations comprising carboxy-methyl cellulose (CMC).

### BACKGROUND OF THE INVENTION

Cosmetic formulations generally include products used for skin care and maintenance, cleansing, odor improvement, hair removal, hair care and maintenance, care and maintenance of mucous membranes, and decorative cosmetics. Further examples and details of these products can be found in Cosmetics, Kirk Othmer Encyclopedia of Chemical Technology, John Wiley & Sons, Inc., online posting date: Dec. 4, 2000.

Cosmetic formulations comprising CMC are known in the art. These formulations comprise conventional CMCs with varying degrees of polymerization serving as thickening agent, stabilizer, retention agent or lubricant in these formulations. Until now, however, the use of conventional CMC in cosmetics has been limited due to adhesion properties and insufficient gelling properties.

It is an object of the present invention to provide an improved cosmetic formulation comprising a carboxymethyl cellulose, more specifically, a cosmetic formulation having an improved rheological behavior, texture and elasticity, enhanced water retention and (storage) stability.

### SUMMARY OF THE INVENTION

The present invention generally relates to a cosmetic formulation comprising 0.01 to 5% by weight (wt %), based on the total weight of the formulation, of a carboxymethyl cellulose (CMC), wherein the CMC is characterized by forming a gel at 25° C. after high-shear dissolution in a 0.3 wt % aqueous sodium chloride solution, the final content of the CMC in the aqueous sodium chloride solution being 1 wt % for a CMC having a degree of polymerization (DP) of >4,000, 1.5 wt % for a CMC having a DP of 3,000-4,000, 2 wt % for a CMC having a DP of 1,500-<3,000, and 4 wt % for a CMC having a DP of <1,500, the gel being a fluid having a storage modulus (G′) which exceeds the loss modulus (G″) over the entire frequency region of 0.01-10 Hz when measured on an oscillatory rheometer operating at a strain of 0.2.

### DETAILED DESCRIPTION OF THE DRAWINGS

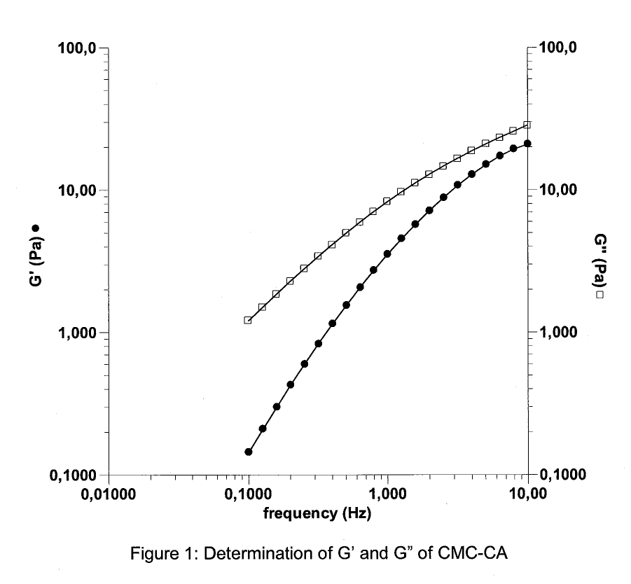

FIG. 1: Flow Diagram for Determination of G′ and G″ of CMC-CA

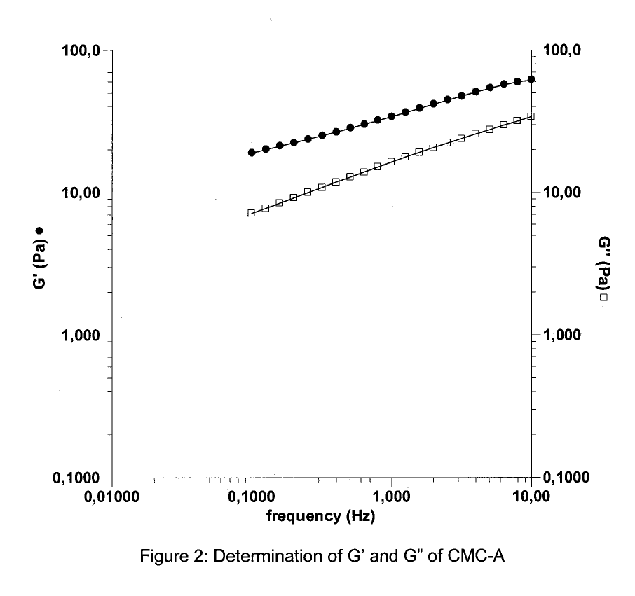

FIG. 2: Flow Diagram for Determination of G′ and G″ of CMC-A

### DETAILED DESCRIPTION OF THE INVENTION

The present invention provides a cosmetic formulation comprising 0.01 to 5% by weight (wt %), based on the total weight of the formulation, of a carboxymethyl cellulose (CMC), wherein the CMC is characterized by forming a gel at 25° C. after high-shear dissolution in a 0.3 wt % aqueous sodium chloride solution, the final content of the CMC in the aqueous sodium chloride solution being 1 wt % for a CMC having a degree of polymerization (DP) of >4,000, 1.5 wt % for a CMC having a DP of 3,000-4,000, 2 wt % for a CMC having a DP of 1,500-<3,000, and 4 wt % for a CMC having a DP of <1,500, the gel being a fluid having a storage modulus (G′) which exceeds the loss modulus (G″) over the entire frequency region of 0.01-10 Hz when measured on an oscillatory rheometer operating at a strain of 0.2.

In the context of the present specification, the abbreviation CMC stands for carboxymethyl cellulose as well as for salts of carboxymethyl cellulose, for example sodium carboxymethyl cellulose.

The CMC of the invention provides the cosmetic formulations with improved rheological behavior, gelling properties, texture and elasticity, enhanced water retention and (storage) stability. Moreover, the amount of said CMC may generally be lower than the amount of conventional CMC. The use of the CMC of the invention does not require neutralization by a neutralizing agent such as triethanol amine, which is necessary when a synthetic thickener such as cross-linked carboxyvinyl polymer is used.

The CMC is suitably used in formulations provided in tubes, e.g. gel shampoos and styling gels, due to its shear-thinning or pseudoplastic behavior enabling a smooth and easy removal of the formulation through the relatively small opening of the tube.

The cosmetic formulations, such as products used for skin care and maintenance, cleansing, odor improvement, hair removal, hair care and maintenance, care and maintenance of mucous membranes, and decorative cosmetics, of the invention can be in any form known in the art. Generally, such formulations are in the form of an emulsion, a dispersion, a suspension, a foam or a solution. In one embodiment of the invention, the cosmetic formulation is an emulsion, a dispersion or a foam, comprising liquid, solid or gaseous particles, respectively. The CMC of the invention allows a uniform distribution of such particles in the formulation, it considerably reduces coalescence of these particles and provides good stabilization thereof. The emulsion, dispersion or foam maintains its (initial) freshness and can be used over a longer period of time.

The average particle size of the solid, liquid or gaseous particles generally is at most 5 mm, preferably at most 2 mm, and most preferably at most 1 mm, and generally at least 0.1 μm, preferably at least 0.5 μm, and most preferably at least 1 μm. Formulations of the invention with particles of the aforementioned sizes generally show a good uniform distribution of small particles and an improved stability upon storage compared to formulations comprising conventional CMCs.

If the formulation is an emulsion and comprises liquid particles, the average particle size is at most 500 μm, preferably at most 100 μm, and most preferably at most 50 μm, and generally at least 0.1 μm, preferably at least 0.5 μm, and most preferably at least 0.8 μm.

Examples of emulsions of the invention are body creams, body lotions, sun screens, and facial masks. Examples of dispersions or suspensions are mascara, body washes, foundations, and styling gels (comprising solid particles). Examples of foams are shaving creams, hair mousses, and foamy handsoaps.

Alternatively, the CMC of the invention can be used in formulations free of solid, liquid or gaseous particles such as a solution. Examples of solutions are hair shampoos including gel shampoos and styling gels (free of solid particles).

The amount of CMC in the formulations of the invention generally is at most 5 wt %, preferably at most 3 wt %, more preferably at most 1 wt %, and most preferably at most 0.9 wt %, and generally at least 0.01 wt %, preferably at least 0.05 wt %, and most preferably at least 0.1 wt %. Generally, a lower amount of CMC of the invention can be used compared to conventional CMC.

It is also contemplated to use the CMC of the invention and one or more conventional thickening agents such as conventional CMC, hydroxypropyl methyl cellulose (HPMC), xanthan gum, and cross-linked carboxyvinyl polymers (e.g. carbomer). The weight ratio of the CMC of the invention to the conventional thickening agent may be from 1:100 to 100:1, preferably from 1:50 to 50:1, and most preferably from 1:10 to 10:1.

The definition of a gel can also be given in terms of the loss angle, delta, which can be calculated from the formula: G″/G′=tan delta. The CMC to be used in accordance with the present invention has a delta smaller than 45°.

The CMC according to the invention obtains its highest viscosity and gelation properties when dissolved under high-shear mixing. Formulations of the invention may be prepared under such high-shear mixing conditions. Apparatus for high-shear dissolution are known to a person of ordinary skill in the art. High-shear dissolution typically is achieved by using a Waring blender or Ultra-Turrax. These apparatus typically operate at approx. 10,000 rpm or more.

The CMC to be used in accordance with the present invention can be obtained by the processes described by D. J. Sikkema and H. Janssen in Macromolecules, 1989, 22, 364-366, or by the process disclosed in WO 99/20657. The procedures and apparatus to be used are conventional in the art and variations on these known procedures can easily be made by a person skilled in the art using routine experimentation. In particular, we have found that the amount of water which is used in the process and the temperature during the alkalization are important parameters for obtaining the CMC in accordance with the present invention. Typically, a 20-40 wt % (final content) aqueous alkali metal hydroxide solution (e.g. aqueous sodium hydroxide solution) is used.

The characterization of CMCs in many cases depends on rheology measurements, in particular viscosity measurements. See, e.g., J. G. Westra, Macromolecules, 1989, 22, 367-370. In this reference, the properties of the CMCs obtained via the process disclosed by Sikkema and Janssen in Macromolecules, 1989, 22, 364-366, are analyzed. Important properties of a CMC are its viscosity, thixotropy, and shear-thinning effect.

The rheology of aqueous solutions of the CMC according to the invention is rather complex and depends on a number of parameters including the degree of polymerization (DP) of the cellulose, the degree of substitution (DS) of the carboxymethyl groups, and the uniformity or non-uniformity of substitution, i.e. the distribution of carboxymethyl groups over the cellulose polymer chains.

The degree of polymerization (DP) of the CMC to be used in accordance with the present invention can vary over a broad range. It is noted that a skilled person will understand that the term “degree of polymerization” refers to the average degree of polymerization, which means the average number of glucose units in the cellulose polymer chain. The degree of polymerization is determined by the formula DP=Mn/Mo, wherein Mn is the number average molecular weight and Mo is the molecular weight of a monomeric unit. In the context of the present invention, a distinction is made between the following DP ranges: >4,000, >3,000-4,000, 1,500-3,000, and <1,500. Typically, the CMC is prepared from linters cellulose (DP typically >4,000-7,000), wood cellulose (DP typically 1,500-4,000) or depolymerized wood cellulose (DP typically <1,500).

Depending on the performance and functionality desired for (the CMC in) the cosmetic formulation of the invention, a CMC with a certain DP value can be used. Different DP values will give a different pseudoplasticity, gel-strength, and thickening performance.

The CMC to be used in accordance with the present invention typically has a DS of at least 0.6, preferably at least 0.7, and most preferably at least 0.8, and typically of at most 1.3, preferably at most 1.2, and most preferably at most 1.1.

The Brookfield viscosity (Brookfield LVF, spindle 4, 30 rpm, 25° C.) of the CMC of the present invention is measured after high-shear dissolution, for example using a Waring blender, of the CMC of the present invention in a 0.3 wt % aqueous sodium chloride solution, the final content of the CMC in the aqueous sodium chloride solution being 1 wt % for a CMC having a degree of polymerization (DP) of >4,000, 1.5 wt % for a CMC having a DP of >3,000-4,000, 2 wt % for a CMC having a DP of 1,500-3,000, and 4 wt % for a CMC having a DP of <1,500. Preferably, a CMC having a viscosity of more than 9,000, more preferably of more than 9,500, even more preferably of more than 10,000 mPa·s, is used.

Aqueous solutions of the CMC to be used in accordance with the present invention are thixotropic. The thixotropy can be determined by preparing a 1 wt % aqueous CMC solution and measuring the viscosity as a function of the shear rate (i.e. 0.01-300 s⁻¹) on a controlled rate or controlled stress rheometer in rotational mode at 25° C. using a cone-plate, parallel-plate or bob-cup geometry. An upcurve is recorded in which the shear rate is increased from 0.01 to 300 s⁻¹ in 3 minutes, immediately followed by the recording of a downcurve in which the shear rate is decreased over the same range and time. For a CMC in accordance with the present invention, the upcurve will be at a higher viscosity level than the downcurve and the area between the two curves is a measure for thixotropy, also referred to as the thixotropy area. Typically, one speaks of a thixotropic solution when the area has a value of 5 Pa.s.s⁻¹ or more when measured at 2 to 4 hours after preparation of the aqueous solution.

The CMC to be used in accordance with the present invention typically is added as a dry powder, but it can also be supplied as a suspension or as an aqueous solution. Furthermore, the CMC according to the invention can be a purified grade or a technical grade (containing the by-products NaCl and sodium glycolates).

Apart from the CMC of the invention, the cosmetic formulations of the invention comprise ingredients commonly used in such formulations. Examples of such ingredients include antioxidants, preservatives, lipids, solvents, surfactants, and colorants. Further details can be found in Chapter 6 of Cosmetics, Kirk Othmer Encyclopedia of Chemical Technology, John Wiley & Sons, Inc., online posting date: Dec. 4, 2000.

The invention is further illustrated with the following Examples.

### EXAMPLES

Akucell AF 2985 (further referred to as “CMC-CA”) ex Akzo Nobel Chemicals B.V. is a CMC which is not in accordance with the present invention, as demonstrated in FIG. 1.

CMC-A: CMC-A is a CMC in accordance with the present invention, as demonstrated in FIG. 2, prepared from linters cellulose, with a DP of 6,500 and a DS of 0.75. A 1 wt % aqueous solution of this product has a Brookfield viscosity of over 12,000 mPa·s using a Heidolph Mixer at 2,000 rpm and of well over 20,000 mPa·s using a Waring Blender at 10,000 rpm. (i.e. high shear). CMC-A has a pseudoplastic rheology and a tendency to thicken up in time, that is, it has a strong thixotropic rheology. A thixotropic area of more than 250 Pa.s.s⁻¹ was calculated using the appropriate method. CMC-A does not dissolve in a salt or acid solution under normal mixing conditions (i.e. propellor blade mixer at 2,000 rpm). At high shear (i.e. Waring Blender at over 10,000 rpm) CMC-A only dissolves when low weight percentages of salt and/or acid are used.

CMC-B: CMC-B is a CMC in accordance with the present invention, prepared from linters cellulose, with a DP of 6,500 and a DS of 0.85. A 1 wt % aqueous solution of this product has a Brookfield viscosity of 8,500 mPa·s using a Heidolph mixer at 2,000 rpm and of 8,000 mPa·s using a Waring blender at 10,000 rpm (i.e. high shear). CMC-B has a pseudoplastic rheology and a tendency to thicken up in time, that is, it has a thixotropic rheology. A thixotropy area of 40 Pa·s·s⁻¹ was calculated using the method described therefor.

### Example 1

A gel shampoo in accordance with the invention was prepared with the ingredients represented in Table 1.

TABLE 1
Gel Shampoo

| Ingredient | Amount (wt %) |
|---|---|
| Water | 51.6 |
| CMC-A | 3.0 |
| Sodium lauryl sulfate | 43.0 |
| Cocamide MEA | 2.0 |
| Preservative | 0.3 |
| Fragrance | 0.1 |

The gel shampoo of Example 1 is a stable non-flowing gel which can be very suitably used in a tube. The shear-thinning behavior of the gel shampoo allows the shampoo to be pushed through the small opening of the tube with considerable ease.

### Example 2

A styling gel in accordance with the invention was prepared with the ingredients represented in Table 2.

TABLE 2
Styling gel

| Ingredient | Amount (wt %) |
|---|---|
| Water | 84.7 |
| Magnesium aluminium silicate | 10.0 |
| CMC-B | 2.0 |
| Polysorbate 20 | 2.0 |
| Methyl paraben | 0.3 |
| Triethanol amine | 1.0 |

The styling gel of Example 2 is a stable non-flowing gel.

### Example 3

A foundation in accordance with the invention was prepared with the ingredients represented in Table 3.

TABLE 3
Foundation

| Ingredient | Amount (wt %) |
|---|---|
| Phase A | |
| Water | 70.4 |
| Magnesium aluminium silicate | 0.2 |
| CMC-B | 0.2 |
| Triethanol amine | 0.7 |
| Dicaprylyl ether | 6.0 |
| Phase B | |
| Titanium dioxide | 6.5 |
| Iron oxide pigment | Q.S. |
| Phase C | |
| Isopropyl myristate | 2.0 |
| H.D. Oleyl alcohol C.G. | 6.5 |
| Mineral oil/lanolin alcohol | 4.5 |
| Hydrophilic wax | 2.0 |
| Stearic acid | 1.0 |
| Phase D | |
| Perfume oil | Q.S. |
| Preservatives | Q.S. |

Q.S. stands for Quantum Satis, or “as much as needed”.

The foundation of Example 3 combines good water retention and rheology with a good stability.

### Example 4

A sun screen in accordance with the invention was prepared with the ingredients represented in Table 4.

TABLE 4
Sun screen

| Ingredient | Amount (wt %) |
|---|---|
| Water Phase | |
| Deionized water | 73.4 |
| Actiphyte Arnica/Actiphyte Lemon | 1.0 |
| Bioflavonoids | 3.0 |
| CMC-A | 1.0 |
| Methyl paraben | 0.6 |
| Oil Phase | |
| Octinoxate | 6.0 |
| Octacrylene | 6.0 |
| Wheat germ oil | 2.0 |
| PEG-8 Beeswax | 2.0 |
| Kostol BAQ | 1.5 |
| Isopropyl myristate | 1.5 |
| Siliconyl beeswax | 3.0 |
| Siliconyl polyethylene | 2.0 |
| Hydroxy polyester K-82P | 0.5 |
| Phenyltrimethicone | 1.0 |
| Polyoxyethylene sorbitan monostearate | 1.0 |

The sun screen of the invention has good film-forming properties, it accentuates lubricity, and has a good feel. Moreover, the sun screen remained stable for more than 3 months of storage.

### Example 5

Two body washes were made, one comprising CMC-A, which is in accordance with the invention (Example 5), and the other comprising CMC-CA, which is not (Comparative Example 5). The composition of the body washes is shown in Table 5.

TABLE 5
Body Wash

| | Example 5 | Comp. Ex. 5 |
|---|---|---|
| Ingredient | Amount (wt %) | Amount (wt %) |
| Water | 89.5 | 89.5 |
| CMC-A | 1.0 | |
| CMC-CA | | 1.0 |
| Sodium lauryl sulfate | 7.0 | 7.0 |
| Cocoamide MEA cocoamidopropyl | 1.0 | 1.0 |
| Betaine | 1.0 | 1.0 |
| Na₃EDTA | 0.1 | 0.1 |
| Fragrance | 0.1 | 0.1 |
| Wax beads | 0.1 | 0.1 |

The body wash of Example 5 (in accordance with the invention) remained stable after 3 months of storage, while the body wash of Comp. Example 5 (not in accordance with the invention) showed settling of the solid wax particles after 1 day of storage. Moreover, the body wash of Example 5 has a pleasant silky, non-greasy feel. The body wash of Example 5 further has improved gelling properties such as an improved yield value, while the body wash of Comp Ex. 5 does not have these improved gelling properties.

### Example 6

A body lotion in accordance with the invention was prepared with the ingredients represented in Table 6.

TABLE 6
Body Lotion

| Ingredient | Amount (wt %) |
|---|---|
| Water | 85.1 |
| Disodium EDTA | 0.1 |
| CMC-B | 0.6 |
| Propylene glycol | 0.8 |
| Methyl Paraben | 0.2 |
| Glycerin dimethicone PEG-7 | 5.0 |
| Cocoate | 0.5 |
| Stearic acid | 2.0 |
| Lanolin | 0.5 |
| Mineral oil | 4.0 |
| Glyceryl stearate | 0.5 |
| Cetyl alcohol | 0.2 |
| Triethanol amine | 0.5 |

The body lotion of Example 6 remained stable after 3 months of storage, and has a silky, non-greasy feel.

1. A cosmetic formulation comprising 0.01 to 5% by weight, based on the total weight of the formulation, of a carboxymethyl cellulose (CMC), wherein the CMC is characterized by forming a gel at 25° C. after high-shear dissolution in a 0.3 wt % aqueous sodium chloride solution, the final content of the CMC in the aqueous sodium chloride solution being 1 wt % for a CMC having a degree of polymerization (DP) of >4,000, 1.5 wt % for a CMC having a DP of 3,000-4,000, 2 wt % for a CMC having a DP of 1,500-<3,000, and 4 wt % for a CMC having a DP of <1,500, the gel being a fluid having a storage modulus (G′) which exceeds the loss modulus (G″) over the entire frequency region of 0.01-10 Hz when measured on an oscillatory rheometer operating at a strain of 0.2.

2. The cosmetic formulation of claim 1 wherein the CMC has a Brookfield viscosity of more than 9,000 mPa·s after high-shear dissolution in a 0.3 wt % aqueous sodium chloride solution, the final content of the CMC in the aqueous sodium chloride solution being 1 wt % for a CMC having a degree of polymerization (DP) of >4,000, 1.5 wt % for a CMC having a DP of >3,000-4,000, 2 wt % for a CMC having a DP of 1,500-3,000, and 4 wt % for a CMC having a DP of <1,500.

3. The cosmetic formulation of claim 1 wherein the formulation is an emulsion or a dispersion.

4. The cosmetic formulation of claim 1 wherein the amount of CMC is from 0.01 to 1 wt %.

5. The cosmetic formulation of claim 1 wherein the amount of CMC is from 0.1 to 0.9 wt %.
